(19) United States
(12) Patent Application Publication
(10) Pub. No.: US 2009/0161815 A1
(43) Pub. Date: Jun. 25, 2009

(54) DUAL SPECTRUM X-RAY TUBE WITH SWITCHED FOCAL SPOTS AND FILTER

(75) Inventors: Michael Grass, Buchholz in der Nordheide (DE); Dye Jensen, Hamburg (DE); Dirk Schäfer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,110

(22) PCT Filed: Mar. 15, 2007
(86) PCT No.: PCT/IB07/50894

§ 371 Date: Oct. 6, 2008

(30) Foreign Application Priority Data
Apr. 7, 2006 (EP) 06112394.9

(51) Int. Cl. H05G 1/60; G06K 9/00

(52) U.S. Cl. 378/5; 382/100

(57) ABSTRACT

In three-dimensional computed tomography or three-dimensional rotational X-ray imaging, the acquisition of different spectral measurement data requires subsequent acquisition runs. According to an exemplary embodiment of the present invention, an examination apparatus is provided in which different spectral measurement data are acquired immediately one after another during the same acquisition run by performing a focal spot switching during data acquisition. This may reduce motion artefacts.

The invention relates to the field of tomographic imaging. In particular, the invention relates to an examination apparatus for dual spectrum examination of an object of interest, to an image processing device, a method of examination of an object of interest, a computer-readable medium, and a program element.

The X-ray attenuation of matter depends on the emitted spectrum emerging from the X-ray tube. Multiple measurements of the same object, such as a patient or an organ, with different spectra allow improved segmentation of tissues or material labelling either in two-dimensional projection imaging as well as in three-dimensional tomographic imaging.

In three-dimensional computed tomography (CT) or three-dimensional rotational X-ray (3DRX) imaging, different spectral settings may only be applied in subsequent acquisition runs. The inherent time delay between the two measurements may increase the probability of patient/organ motion and related artefacts.

It would be desirable to reduce the acquisition time.

The invention provides an examination apparatus, an image processing device, a method of examining an object of interest with an examination apparatus, a computer-readable medium and a program element with the features according to the independent claims.

It should be noted that the following described exemplary embodiments of the invention apply also for the method of examination of an object of interest, for the computer-readable medium, for the image processing device and for the program element.

According to an exemplary embodiment of the present invention, an examination apparatus for dual spectrum examination of an object of interest may be provided, the examination apparatus comprising a filter unit adapted for filtering a radiation beam from the object of interest, the radiation beam having a focal spot. Furthermore, the examination apparatus comprises a fast focal spot switching unit adapted for switching the focal spot from a first focal spot location to a second focal spot location, and a detector unit adapted for acquiring measurement data on the basis of the radiation beam from the object of interest, wherein the filter unit, the first focal spot location and the second focal spot location are arranged in such a way, that the radiation beam passes through the filter unit when the focal spot is in the first location, resulting in filtered first spectral measurement data, and that the radiation beam does not pass through the filter unit when the focal spot is in the second location, resulting in second spectral measurement data.

Therefore, the examination apparatus may be adapted for performing two reconstructions of two different three-dimensional images of the same object, wherein the two data sets used for these two reconstructions corresponding to the two different images are acquired during the same rotation(s) of the gantry.

Since the focal spot of the radiation beam is switched in such a way that the emerging beam passes through a spectral filter device for one focal spot location, whereas the beam is unaffected by the filtering device when directed to another focal spot location, different spectral measurements may, according to another exemplary embodiment of the invention, be taken immediately one after another.

According to another exemplary embodiment of the present invention, the fast focal spot switching unit is adapted as one of a fast electric focal spot switching unit and a magnetic quadrupole switching unit. Such units are disclosed in “Electron Beam Technology”, S. Schiller, U. Heisig, S. Panzer John Wiley and Sons, New York, USA 1982, which is hereby incorporated by reference.

Therefore, according to this exemplary embodiment of the present invention, two (or multiple) different spectral measurements may be taken with considerable speed immediately one after another during the same acquisition run. This may lead to a considerable reduction of overall acquisition time.

According to another exemplary embodiment of the present invention, the electric focal spot switching unit is adapted as one of a grid switch and a plate switch. Such switches are disclosed in “Electron Beam Technology”, S. Schiller, U. Heisig, S. Panzer John Wiley and Sons, New York, USA 1982, which is hereby incorporated by reference.

According to another exemplary embodiment of the present invention, the filter unit comprises a copper plate. It should be noted however, that other materials may be applied. Furthermore, other types of filters may be applied, such as, for example, an additional aluminium filter of 2.5 mm thickness or a titanium filter.

According to another exemplary embodiment of the present invention, the examination apparatus further comprises a radiation source adapted as a X-ray tube, wherein the radiation beam is a X-ray beam emitted from the X-ray tube.

Therefore, the radiation source may be adapted in form of a dual spectrum tube which is able to perform a focal spot switching on a fast time scale.

According to another exemplary embodiment of the present invention, the examination apparatus is adapted as one of a three-dimensional computed tomography apparatus and a three-dimensional rotational X-ray apparatus.

It should be noted in this context, that the present invention is not limited to computer tomography, but may always then be applied when two different images of the same object have to be acquired by changing the spectral setting.

According to another exemplary embodiment of the present invention, a distance of the first focal spot location and the second focal spot location is in the order of a nominal focal spot value of the radiation beam.

In other words, the distance between the two spot locations is in the order of the projected spot size.

According to another exemplary embodiment of the present invention, the first focal spot location and the second focal spot location are located on a line orthogonal to a rotational axis of the radiation source.

Thus, according to this exemplary embodiment of the present invention, the focal spot may be switched orthogonal to the rotational axis of the anode disk.

According to another exemplary embodiment of the present invention, the first focal spot location and the second focal spot location are located on a line having a component parallel to the rotational axis of the radiation source.

Therefore, the switching direction is parallel to the rotational axis of the anode disk.

According to another exemplary embodiment of the present invention, the examination apparatus is configured as one of the group consisting of a material testing apparatus, a medical application apparatus and a micro CT system. A field of application of the invention may be medical imaging, in particular 3D rotational X-ray imaging.

According to another exemplary embodiment of the present invention, an image processing device for examination of an object of interest may be provided, the image processing device comprising a memory for storing a data set of the object of interest, the data set comprising filtered first spectral measurement data corresponding to a first focal spot location and non-filtered second spectral measurement data corresponding to a second focal spot location, both data acquired immediately one after another during the same acquisition run, and a reconstruction unit adapted for determining a difference between the first spectral measurement data and the second spectral measurement data and reconstructing an image of the object of interest on the basis of the difference.

It should be noted, however, that functions which are applied for determining a difference between the first spectral measurement data and the second spectral measurement data may comprise a subtraction operation or other operations, such as, for example, a non-linear operation with respect to gray scale values (corresponding to intensities or line integrals or energy dependent absorption coefficients) of the corresponding images.

Furthermore, according to another exemplary embodiment of the present invention, the image processing device may be adapted such that the filtered first spectral measurement data and the non-filtered second spectral measurement data are acquired immediately one after another during the same acquisition run by switching the focal spot from the first focal spot location to the second focal spot location, wherein the radiation beam passes through a filter unit when the focal spot is in the first location, resulting in the filtered first spectral measurement data, and wherein the radiation beam does not pass through the filter unit when the focal spot is in the second location, resulting in the second spectral measurement data.

According to another exemplary embodiment of the present invention, a method of examination of an object of interest with an examination apparatus may be provided, the method comprising the steps of detecting filtered radiation having a focal spot at a first focal spot location, resulting in filtered first spectral measurement data, switching the focal spot from the first focal spot location to a second focal spot location, and detecting non-filtered radiation having a focal spot at the second focal spot location immediately after detection of the filtered first spectral measurement data during the same acquisition run, resulting in second spectral measurement data.

This may provide for a fast and effective examination method yielding to a reduction of motion artefacts.

According to another exemplary embodiment of the present invention, the method further comprises the steps of determining a difference between the first spectral measurement data and the second spectral measurement data, and reconstructing an image of the object of interest on the basis of the difference.

Therefore, according to this exemplary embodiment of the present invention, the method may be used to reconstruct two different three-dimensional images of the same object. By simple subtraction of the images, the distinction of, for example, blood vessels and skull bone may be improved in three-dimensional neuroangiography.

Furthermore, projections acquired in the same imaging geometry with different spectra may also be decomposed into different physical (Compton/Raleigh-scatter) projection images, as disclosed in R. E. Alvarez and A. Macovski, “Energy-selective reconstructions in x-ray computerized tomography,” Phys. Med. Biol. 21, 733-744, 1976; and in R. E. Alvarez and A. Macovski, “X-ray spectral decomposition imaging system,” U.S. Pat. No. 4,029,963, 1977, which are hereby incorporated by reference.

Furthermore, the different physical projection images may be used for two-dimensional or three-dimensional analysis.

Beyond this, according to another exemplary embodiment of the present invention, a computer-readable medium may be provided, in which a computer program of examination of an object of interest is stored which, when being executed by a processor, is adapted to carry out the above-mentioned method steps.

Furthermore, according to another exemplary embodiment of the present invention, a program element of examination of an object of interest may be provided, which, when being executed by a processor, is adapted to carry out the above-mentioned method steps.

The examination of the object of interest may be realized by the computer program, i.e. by software, or by using one or more special electronic optimization circuits, i.e. in hardware, or in hybrid form, i.e. by means of software components and hardware components.

The program element according to an exemplary embodiment of the present invention may preferably be loaded into working memories of a data processor. The data processor may thus be equipped to carry out exemplary embodiments of the methods of the present invention. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the present invention that the focal spot of an X-ray tube is switched in such a way that at one focal spot position a filtering is performed and that at a second focal spot position no filtering is performed. Thus, two or more different spectral measurements may be taken immediately one after another by switching in a fast manner. Therefore, different spectral settings may be applied during the same acquisition run.

These and other aspects of the present invention will become apparent from and elucidated with reference to the embodiments described hereinafter.

Exemplary embodiments of the present invention will be described in the following, with reference to the following drawings.

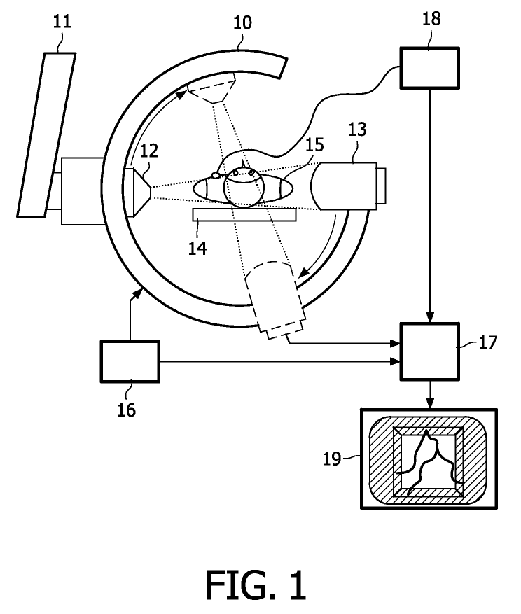

FIG. 1 shows a simplified schematic representation of an examination apparatus according to an exemplary embodiment of the present invention.

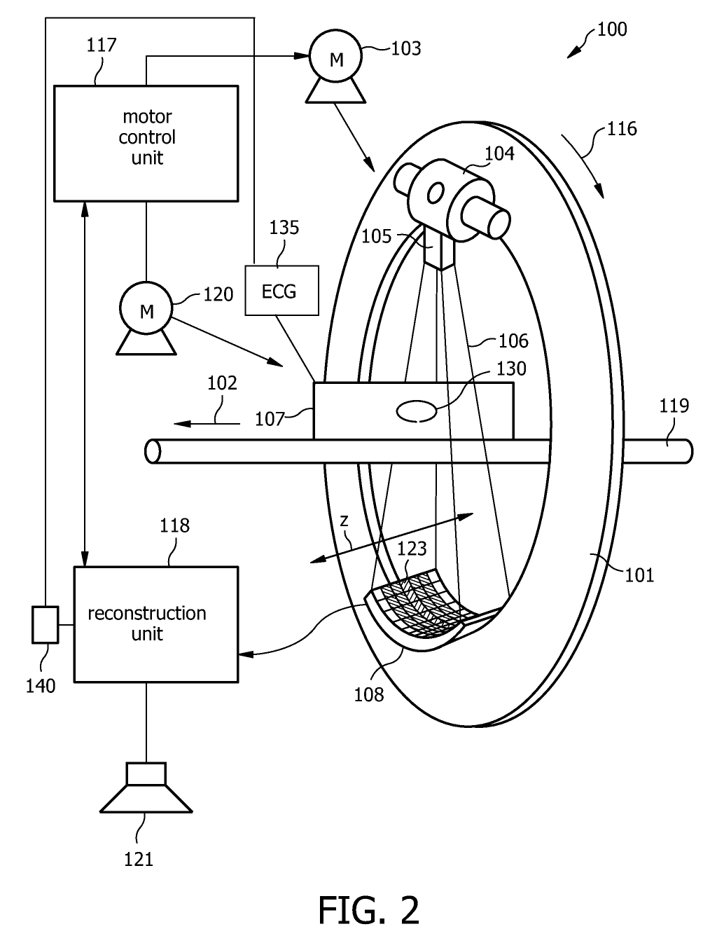

FIG. 2 shows a simplified schematic representation of an examination apparatus according to an other exemplary embodiment of the present invention.

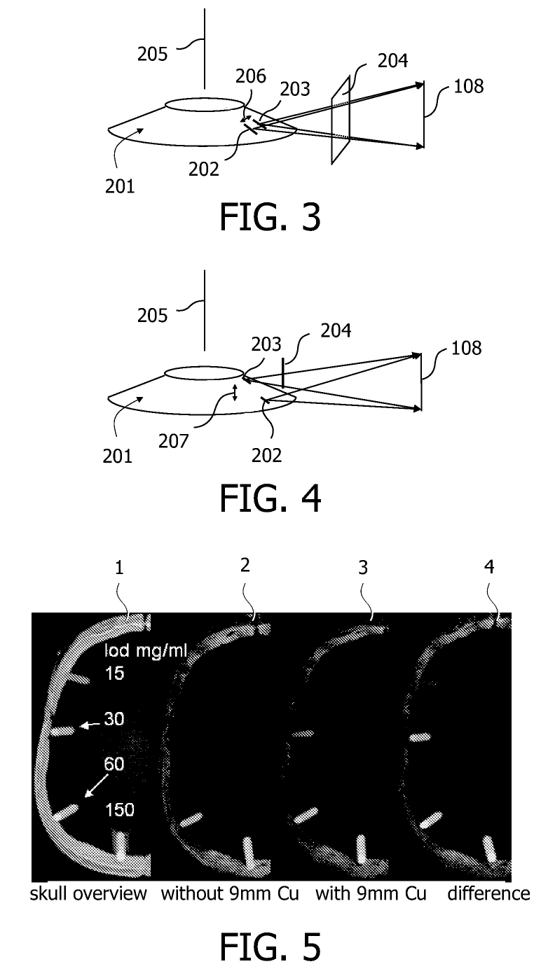

FIG. 3 shows a schematic representation of a dual focal spot geometry with filtering device according to an exemplary embodiment of the present invention.

FIG. 4 shows a dual focal spot geometry with filtering device according to another exemplary embodiment of the present invention.

FIG. 5 shows a schematic representation of a phantom study representing the improvement of the image quality according to the present invention.

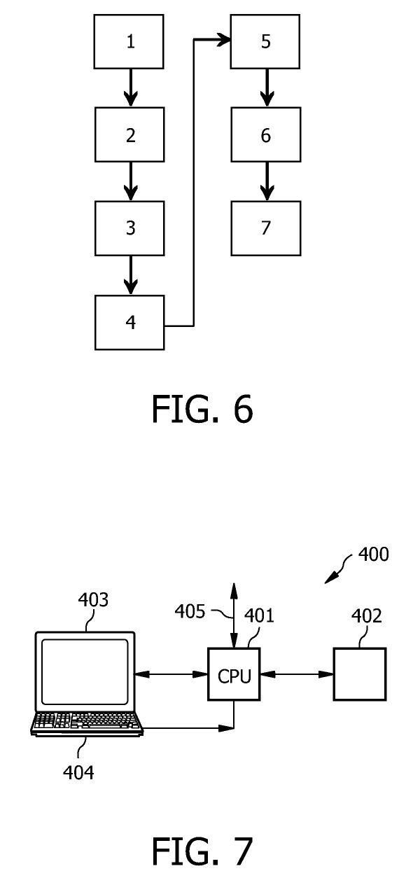

FIG. 6 shows a flow-chart of an exemplary method according to the present invention.

FIG. 7 shows an exemplary embodiment of an image processing device according to the present invention, for executing an exemplary embodiment of a method in accordance with the present invention.

The illustration in the drawings is schematically. In different drawings, similar or identical elements are provided with the same reference numerals.

FIG. 1 shows a simplified schematic representation of an examination apparatus according to an exemplary embodiment of the present invention.

The invention may be applied in the field of three-dimensional rotational x-ray imaging or three-dimensional rotational aniography imaging. In such a case, the examination may be performed with conventional x-ray systems.

The invention may be particularly be used when a contrast agent has to be separated from bone, which is the case, e.g., in the field of neuroradiological examination of a patient.

It may always (and in particular for 3D-RX) be important to have a fast, energy resolved image acquisition process, since the contrast agent only stays in the corresponding vessels for a relatively short time period and because the acquisition system is rotating (i.e. moving).

The apparatus depicted in FIG. 1 is a C-arm x-ray examination apparatus, comprising a C-arm 10 attached to a ceiling (not depicted in FIG. 1) by means of an attachment 11. C-arm 10 holds the x-ray source 12 and detector unit 13, which may be rotatably mounted to the C-arm 10, such that a plurality of projection images of a patient 15 on table 14 can be acquired under different angles of projection.

Control unit 16 is adapted for controlling a synchronous movement of the source 12 and the detector 13, which both rotate around the patient 15.

The image data generated by the detector unit 13 is transmitted to image processing unit 17 which is controlled by a computer.

Furthermore, a ECG unit 18 may be provided for recording the heart beat of the patient's heart. The corresponding ECG data is the transmitted to image processing unit 17.

The image processing unit 17 is adapted to carry out the method steps according to the invention.

Furthermore, the system my comprise a monitor 19 adapted for visualizing the acquired images.

The invention may also be applied in the field of computed tomography.

FIG. 2 shows an exemplary embodiment of a computed tomography scanner system according to the present invention.

The computer tomography apparatus 100 depicted in FIG. 2 is a cone-beam CT scanner. However, the invention may also be carried out with a fan-beam geometry. In order to generate a primary fan-beam, the aperture system 105 can be configured as a slit collimator. The CT scanner depicted in FIG. 2 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 2, the detector 108 is arranged on the gantry 101 opposite to the source of radiation 104, such that the surface of the detector 108 is covered by the cone beam 106. The detector 108 depicted in FIG. 2 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a reconstruction unit 118 (which might also be denoted as a calculation or determination unit).

In FIG. 2, the object of interest 107 is a human being which is disposed on an operation table 119. During the scan of, e.g., the heart 130 of the human being 107, while the gantry 101 rotates around the human being 107, the operation table 119 displaces the human being 107 along a direction parallel to the rotational axis 102 of the gantry 101. By this, the heart 130 is scanned along a helical scan path. The operation table 119 may also be stopped during the scans to thereby measure signal slices. It should be noted that in all of the described cases it is also possible to perform a circular scan, where there is no displacement in a direction parallel to the rotational axis 102, but only the rotation of the gantry 101 around the rotational axis 102.

Moreover, an electrocardiogram device 135 may be provided which measures an electrocardiogram of the heart 130 of the human being 107 while X-rays attenuated by passing the heart 130 are detected by detector 108. The data related to the measured electrocardiogram are transmitted to the reconstruction unit 118.

The detector 108 is connected to the control unit 118. The reconstruction unit 118 receives the detection result, i.e. the read-outs from the detector elements 123 of the detector 108 and determines a scanning result on the basis of these read-outs. Furthermore, the reconstruction unit 118 communicates with the motor control unit 117 in order to coordinate the movement of the gantry 101 with motors 103 and 120 with the operation table 119.

The control unit 118 may be adapted for reconstructing an image from read-outs of the detector 108. A reconstructed image generated by the reconstruction unit 118 may be output to a display (not shown in FIG. 2) via an interface 122.

The reconstruction unit 118 may be realized by a data processor to process read-outs from the detector elements 123 of the detector 108.

The computer tomography apparatus shown in FIG. 2 captures multi-cycle cardiac computer tomography data of the heart 130. In other words, when the gantry 101 rotates and when the operation table 119 is shifted linearly, then a helical scan is performed by the X-ray source 104 and the detector 108 with respect to the heart 130. During this helical scan, the heart 130 may beat a plurality of times. During these beats, a plurality of cardiac computer tomography data are acquired. Simultaneously, an electrocardiogram may be measured by the electrocardiogram unit 135. After having acquired these data, the data are transferred to the reconstruction unit 118, and the measured data may be analyzed retrospectively.

The measured data, namely the cardiac computer tomography data and the electrocardiogram data are processed by the reconstruction unit 118 which may be further controlled via a graphical user-interface (GUI) 140. This retrospective analysis is based on a helical cardiac cone beam reconstruction scheme using retrospective ECG gating. It should be noted, however, that the present invention is not limited to this specific data acquisition and reconstruction.

However, the examination apparatus 100 comprises a filter unit 204 and a fast focal spot switching unit (not depicted in FIG. 2), as described with respect to FIGS. 3 and 4.

FIG. 3 shows a schematic representation of a dual focal spot geometry with filtering device 204 according to an exemplary embodiment of the present invention. The radiation source comprises an anode 201, from which an X-ray beam is emitted towards the object of interest (not depicted in FIG. 2). The X-ray beam is either focused at the first focal spot location 202 or at the second focal spot location 203. The switching between the two focal spot locations 202, 203 is performed orthogonal to the rotational axis 205 in the direction symbolized by arrow 206.

The focal spot of the X-ray tube is switched in such a way that the emerging X-ray beam passes through the spectral filter device 204 (e.g. copper plate) for the first focal spot location 202, whereas for the other focal spot location 203 the X-ray beam is unaffected by the filtering device 204. After passing the filter device 204, the X-ray beam is detected by detector unit 208.

However, for the second focal spot location 203, the beam may be filtered by a second filter (not depicted in FIG. 3) or may remain unfiltered. The second filter may comprise the same material as the first filter but may have different filter properties (e.g. the second filter may be thicker than the first filter 204), or the second filter may be a different type of filter.

By fast electric (grid/plate switch) or magnetic quadrupole switching, two (or multiple) different spectral measurements can be taken immediately one after another.

The two or more different focal spots 202, 203 may correspond to different acceleration voltages of the electron beam, resulting in corresponding different spectral characteristics of the measured data.

The distance of the two (or more) focal spot positions has to be in the order of the nominal focal spot values (projected spot size), which is in the order of 1 mm for typical X-ray tubes. For the switching orthogonal to the rotational axis this may correspond to a similar displacement Δfₓ≈1 mm. For the switching parallel to the rotational axis the displacement Δf_{y}≈1 mm*1/tan(anode angle)=5.1 mm for an anode angle of 11 degree.

It should be noted, that more than two focal spots may be produced on the anode 201, for example four focal spots, all corresponding to different filtering of the x-ray beam. The focal spot may further be moved along the track on the anode 201. Along the track, the beam may be filtered in a varying way (the filter properties continuously or step-like changing with changing focal spot position).

FIG. 4 shows a schematic representation of a dual focal spot geometry with filtering device 204 according to another exemplary embodiment of the present invention. Here, the switching direction of the focal spot position is performed parallel to the rotational axis of the anode disk 201, as symbolized by arrow 207.

As may be seen from FIG. 4, when the focal spot is in position 203, the radiation beam 208 penetrates the filter 204. On the other hand, when the focal spot is in position 202, the corresponding radiation beam 209 does not penetrate the filter 204, resulting in non-filtered measurement data at detector 108.

FIG. 5 shows a schematic representation of a phantom study with a human skull and flexible tubes filled with iodine contrast agent. The left section 1 of FIG. 5 shows the phantom with the flexible tubes 15, 30, 60, 150. Tube 15 is filled with a concentration of 15 mg/ml iodine contrast, tube 30 is filled with a concentration of 30 mg/ml iodine contrast, tube 60 is filled with a concentration of 60 mg/ml iodine contrast and tube 150 is filled with a concentration of 150 mg/ml iodine contrast.

The second section 2 of FIG. 5 shows a reconstructed image of the phantom acquired without a filtering device. The third section 3 of FIG. 5 shows a reconstructed image of the phantom acquired with using a 9 mm thick copper plate as filtering device (thus corresponding to focal spot position 202 of either FIG. 3 or FIG. 4).

Furthermore, the right most section 4 of FIG. 5 shows the reconstructed difference image, acquired according to an exemplary embodiment of the present invention. The visibility of tube 30 with a concentration of 30 mg/ml iodine contrast is significantly improved in this volume rendered view of the reconstructed difference image (as compared to images of sections 2 and 3).

FIG. 6 shows a flow-chart of an exemplary method according to the present invention for performing a dual spectrum examination of an object of interest. The method starts at step 1 with the emission of a beam, such as an X-ray beam, having a focal spot at a first focal spot location. Then, in step 2, the radiation beam is filtered. In step 3, the filtered beam, which has the focal spot at a first focal spot location, is detected, resulting in filtered first spectral measurement data.

In step 4, the focal spot is switched from the first focal spot location to a second focal spot location. After that, in step 5, the non-filtered beam, which has the focal spot at the second focal spot location and which does not penetrate the filter, is detected, resulting in non-filtered second spectral measurement data.

This second data is acquired immediately after the acquisition of the first spectral measurement data during the same acquisition run.

In step 6, a difference between the first spectral measurement data and the second spectral measurement is determined. Then, in step 7, a reconstruction of an image of the object of interest is performed on the basis of the difference.

This may lead to a reduction of the overall acquisition time, since the difference spectral settings are applied during one acquisition run.

FIG. 7 depicts an exemplary embodiment of a data processing device 400 according to the present invention for executing an exemplary embodiment of a method in accordance with the present invention. The data processing device 400 depicted in FIG. 7 comprises a central processing unit (CPU) or image processor 401 connected to a memory 402 for storing an image depicting an object of interest, such as a patient or an item of baggage. The data processor 401 may be connected to a plurality of input/output network or diagnosis devices, such as a CT device. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 7.

Furthermore, via the bus system 405, it may also be possible to connect the image processing and control processor 401 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Exemplary embodiments of the invention may be sold as a software option to CT scanner console, imaging workstations or PACS workstations.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus (100) for dual spectrum examination of an object of interest (107), the examination apparatus (100) comprising:
a filter unit (204) adapted for filtering a radiation beam from the object of interest (107), the radiation beam having a focal spot;
a fast focal spot switching unit adapted for switching the focal spot from a first focal spot location to a second focal spot location;
a detector unit (108) adapted for acquiring measurement data on the basis of the radiation beam from the object of interest (107);
wherein the filter unit (204), the first and the second focal spot location are arranged in such a way, that
the radiation beam passes through the filter unit (204) when the focal spot is in the first location, resulting in filtered first spectral measurement data,
and that the radiation beam does not pass through the filter unit (204) when the focal spot is in the second location, resulting in second spectral measurement data.

2. The examination apparatus (100) of claim 1,
wherein the filtered first spectral measurement data and the non-filtered second spectral measurement data are acquired immediately one after another during the same acquisition run.

3. The examination apparatus (100) of claim 1,
wherein the fast focal spot switching unit is adapted as one of a fast electric focal spot switching unit and a magnetic quadrupole switching unit.

4. The examination apparatus (100) of claim 3,
wherein the electric focal spot switching unit is adapted as one of a grid switch and a plate switch.

5. The examination apparatus (100) of claim 1,
wherein the filter unit (204) comprises a copper plate.

6. The examination apparatus (100) of claim 1, the examination apparatus (100) further comprising:
a radiation source adapted as a X-ray tube (104);
wherein the radiation beam is a X-ray beam emitted from the X-ray tube (104).

7. The examination apparatus (100) of claim 1,
wherein the examination apparatus (100) is adapted as one of a 3D computed tomography apparatus and a 3D rotational X-ray apparatus.

8. The examination apparatus (100) of claim 1,
wherein a distance of the first focal spot location and the second focal spot location is in the order of a nominal focal spot value of the radiation beam.

9. The examination apparatus (100) of claim 1,
wherein the first focal spot location and the second focal spot location are located on a line orthogonal to a rotational axis of the radiation source.

10. The examination apparatus (100) of claim 1,
wherein the first focal spot location and the second focal spot location are located on a line having a component parallel to the rotational axis of the radiation source.

11. The examination apparatus (100) of claim 1, configured as one of the group consisting of a material testing apparatus, a medical application apparatus and a micro CT system.

12. An image processing device for examination of an object of interest (107), the image processing device comprising:
a memory for storing a data set of the object of interest (107), the data set comprising filtered first spectral measurement data corresponding to a first focal spot location and non-filtered second spectral measurement data corresponding to a second focal spot location, both data acquired immediately one after another during the same acquisition run;
a reconstruction unit (118) adapted for:
determining a difference between the first spectral measurement data and the second spectral measurement data; and
reconstructing an image of the object of interest (107) on the basis of the difference.

13. The image processing device of claim 12,
wherein the filtered first spectral measurement data and the non-filtered second spectral measurement data are acquired immediately one after another during the same acquisition run by switching the focal spot from the first focal spot location to the second focal spot location;
wherein the radiation beam passes through a filter unit (204) when the focal spot is in the first location, resulting in the filtered first spectral measurement data,
wherein the radiation beam does not pass through the filter unit (204) when the focal spot is in the second location, resulting in the non-filtered second spectral measurement data.

14. A method of examination of an object of interest (107) with an examination apparatus, method comprising the steps of:
detecting filtered first radiation having a focal spot at a first focal spot location, resulting in filtered first spectral measurement data;
switching the focal spot from the first focal spot location the a second focal spot location;
detecting second radiation having a focal spot at the second focal spot location immediately after detection of the filtered first radiation during the same acquisition run, resulting in second spectral measurement data.

15. The method of claim 14, further comprising the steps of:
determining a difference between the first spectral measurement data and the second spectral measurement data; and
reconstructing an image of the object of interest (107) on the basis of the difference.

16. A computer-readable medium (402), in which a computer program of examination of an object of interest is stored which, when being executed by a processor (401), is adapted to carry out the steps of:
detecting filtered first radiation having a focal spot at a first focal spot location, resulting in filtered first spectral measurement data;
switching the focal spot from the first focal spot location the a second focal spot location;
detecting second radiation having a focal spot at the second focal spot location immediately after detection of the filtered first radiation during the same acquisition run, resulting in second spectral measurement data.

17. A program element of examination of an object of interest, which, when being executed by a processor (401), is adapted to carry out the steps of:
detecting filtered first radiation having a focal spot at a first focal spot location, resulting in filtered first spectral measurement data;
switching the focal spot from the first focal spot location the a second focal spot location;
detecting second radiation having a focal spot at the second focal spot location immediately after detection of the filtered first radiation during the same acquisition run, resulting in second spectral measurement data.
